(19) United States
(12) Patent Application Publication
(10) Pub. No.: US 2009/0219787 A1
(43) Pub. Date: Sep. 3, 2009

(54) TIMER FOR BRUSHING TEETH

(76) Inventor: George Ortega, Glendale, NY (US)

Correspondence Address: HUGHES HUBBARD & REED LLP, ONE BATTERY PARK PLAZA, NEW YORK, NY, 10004, US

(21) Appl. No.: 12/352,492

(22) Filed: Jan. 12, 2009

Related U.S. Application Data
(60) Provisional application No. 61/067,647, filed on Mar. 1, 2008.

(51) Int. Cl. G04B 47/00; G04F 3/00

(52) U.S. Cl. 368/10; 368/98

(57) ABSTRACT

A timer for brushing teeth, comprising a timer having a knob, said timer capable of alerting a user after the elapse of a user-determined time period, and a toy body covering said timer having a mouth portion, said mouth portion coupled to said knob, wherein said user-determined time period is determined by the user by turning said mouth portion by a user-determined number of degrees.

### CROSS REFERENCE TO RELATED APPLICATIONS

this application claims the benefit of the filing date of U.S. Provisional Patent Application Ser. No. 61/067,647 filed Mar. 1, 2008, the entire disclosure of which is incorporated herein by reference.

### BACKGROUND OF THE INVENTION

1. Field of the Invention

The present invention is in the field of electronics, and more particularly in the area of timers set for a pre-specified amount of time to facilitate teeth brushing.

2. Description of Related Art

It is well known in the art for toothbrushes to incorporate a timer set for a pre-specified amount of time, such as two minutes, so that the user using the toothbrush will brush his or her teeth for the dentist-recommended period of two minutes. However, such timers are not children-friendly and often fail to engage children to brush their teeth.

### SUMMARY OF THE INVENTION

The present invention is a timer for brushing teeth that can be used with any toothbrush. It is also an interactive, fun, creative, and unique timer that helps children be aware of the amount of time to brush their teeth and keep children engaged long enough to brush their teeth for a pre-specified amount of time, such as the dentist-recommended period of two minutes.

Other aspects and advantages of the invention will be apparent from the accompanying drawings, and the detailed description that follows.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, in which:

FIG. 1 is a front view of the present invention.

FIG. 2 is a rear view of the present invention.

FIG. 3 is a side view of the present invention.

FIG. 4 is a perspective view of the present invention coupled with a toothbrush.

### DETAILED DESCRIPTION

The following is a detailed description of certain embodiments of the invention chosen to provide illustrative examples of how it may preferably be implemented. The scope of the invention is not limited to the specific embodiments described.

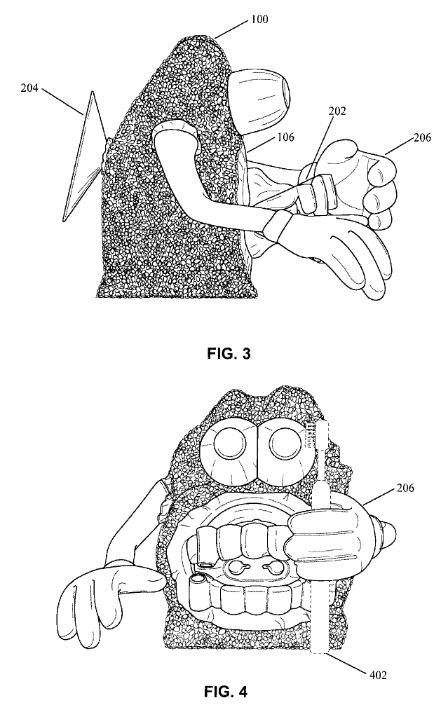

FIG. 1 is a front view of the present invention showing the present invention having a toy body 100 in a shape of toy germ, known as “germies.” Underneath the body 100 is a timer 102 (not shown), which has a knob 104 that is coupled to the mouth 106 of the body 100. The mouth 106 has an extended portion 202, shown on FIG. 3. To start the timer 102, a user rotates the extended portion 202 by certain number of degrees, such as 180 degrees, which will in turn rotate the knob 104. After a pre-specified amount of time corresponding to the number of degrees turned, such as two minutes, the timer 102 will beep, alerting the user that the pre-specified amount of time has elapsed.

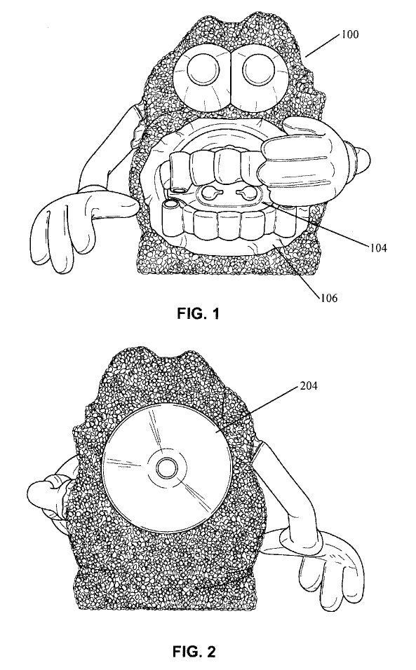

FIG. 2, showing a rear view of the present invention, shows a suction cup 204 attached to body 100, so that the tooth brush time of the present invention can adhere to a wall, such as the wall of a bathroom. FIG. 3 is a side view of the present invention. The timer of the present invention can also have a toothbrush holder 206 used to hold a toothbrush. FIG. 4 illustrates the operation of the toothbrush holder 206 by showing a toothbrush 402 coupled to the toothbrush holder 206.

The shape of the toy body 100 is not limited to the shape shown in the figures. The designs of the toy boy 100 can come in different shape, colors, and personalities.

Although the present invention has been described in detail, it should be understood that various changes, substitutions, and alterations may be readily ascertainable by those skilled in the art and may be made herein without departing from the spirit and scope of the present invention as defined by the following claims.

What is claimed is:

1. A timer for brushing teeth comprising: a timer having a knob, said timer capable of alerting a user after the elapse of a user-determined time period; and a toy body covering said tinter having a mouth portion, said mouth portion coupled to said knob, wherein said user-determined time period is determined by the user by turning said mouth portion by a user-determined number of degrees.

2. The timer for brushing teeth of claim 1, wherein the maximum number of degrees that the user can turn said mouth portion is 180 degrees.

3. The timer for brushing teeth of claim 2, wherein the user-determined time period corresponding to said turn of said mouth portion of 180 degrees is two minutes.

4. The timer for brushing teeth of claim 1, further comprising a suction cup attached to back of said toy body for attaching said timer to a wall.

5. The timer for brushing teeth of claim 1, further comprising a toothbrush holder.
